(19) United States
(12) Patent Application Publication
(10) Pub. No.: US 2010/0099461 A1
(43) Pub. Date: Apr. 22, 2010

(54) Cellular Phone Data Streaming for Surveillance and Personal Security

(75) Inventors: James Rahfaldt, Rolling Meadows, IL (US); James Richie, Rolling Meadows, IL (US)

Correspondence Address: MILLER, MATTHIAS & HULL, ONE NORTH FRANKLIN STREET, SUITE 2350, CHICAGO, IL, 60606, US

(73) Assignee: X-TEL Communications, Inc., Rolling Meadows, IL (US)

(21) Appl. No.: 12/256,140

(22) Filed: Oct. 22, 2008

(51) Int. Cl. H04M 1/00

(52) U.S. Cl. 455/557

(57) ABSTRACT

A cellular phone having means for streaming and storing audio, video and photographic data at a remote host for the purposes of personal security and surveillance is disclosed. A cellular phone having a camera, a microphone, a panic trigger, and means for communicating with a wireless network may be used to capture and stream audio, video and photographic data to at least one host of the wireless network. The host may simultaneously provide live streaming audio, video and photographic data to anyone granted access to the host and remotely store the data for future access. Methods and systems for enabling a cellular phone to stream and remotely store captured audio, video and photographic data are also disclosed.

### FIELD OF THE DISCLOSURE

The present disclosure generally relates to cellular phones capable of streaming data for the purposes of personal security and surveillance, and more particularly, relates to a cellular phone capable of streaming images, video and/or audio to a host for remote storage.

### BACKGROUND OF THE DISCLOSURE

Cellular phones are well known in the art and have become a necessity for millions of people worldwide. Significant advances in wireless technology over the years have made it possible to provide inexpensive cellular phones and wireless communication services to the general population. Today, a cellular phone may support one or more of a variety of wireless communication technologies such as GSM, CDMA, WCDMA, WiMAX, WiFi, and the like. In terms of frequency bands, a cellular phone may support a broad spectrum of frequencies, for example, 700 MHz, 800 MHz and 1900 MHz for use in the United States, and 450 MHz, 900 MHz, 1800 MHz and 2100 MHz for us in Europe. As the dependencies on cellular phones continue to grow, demands for cellular phones that serve as an all-in-one tool are also thriving. Continuous developments in response to such demands have resulted in cellular phones that provide much more than just voice calls. Among other things, a modern day cellular phone features and/or supports calendars, organizers, text messages, electronic or emails, games, calculators, web browsers, memory cards, media players, cameras, touch-screen displays, accelerometers, global positioning systems (GPS), and the like. Cellular phones have become some of the most technologically advanced handheld tools most frequently used today. However, even in the most advanced cellular phones, there are no substantial measures providing personal security and surveillance.

Although a cellular phone may provide some degree of security, there is still room for improvement. Even with the most advanced cellular phones, the options these devices provide in terms of security and surveillance are minimal. For instance, upon witnessing or becoming a victim of a criminal act, one option available to a cellular phone user may be to contact an emergency number, family members or friends for help. The only other option may be to capture photos, video and/or audio recordings of the incident for use as evidence at a later time. However, there are significant drawbacks to each of these options as discussed more specifically below.

Cellular phones are frequently used to report emergencies and/or criminal acts and to call authorities for help. However, in many cases, placing a phone call may not be a viable option. For instance, in the event of a personal attack, someone being approached by a perpetrator may not have the time or ability to dial someone for help without risking some type of adverse response from the perpetrator. If present, a bystander or witness to the attack may also decide to use his or her cellular phone to call for help. However, if the call is overheard, the perpetrator may be provoked to move the current victim to another location, attack the witness, or the like. To avoid being heard, a cellular phone user may choose to text or email someone for help. However, correspondence by text or email is relatively slow, and most people are unfamiliar with the number or address to text or email to for such emergencies.

Victims or witnesses to a crime or a similar emergency may also choose to make a record of the incident to be used as evidence at a later time. Specifically, on some cellular phones, it is possible to take photographs or record videos and/or audio, and store the data locally on memory of the cellular phone. However, whether it is internal or removable, the memory capacity is relatively small, and therefore, free space may not be readily available for emergencies or other urgent needs. More importantly, if the cellular phone is ever lost, destroyed or stolen, the data is irretrievable. Additionally, many cellular phones are required to play a sound when capturing photographs or recording video, which may prove to be undesirable in some emergency situations. On supported cellular phones it is also possible to send captured photographs, video and audio files as an attachment to a text message, multimedia text message or email. However, not everyone may have cellular phones or services that support receiving such files or messages, and therefore, the data may not transfer successfully. Furthermore, sending and receiving such files over the wireless network may prove to be a time consuming process. Because of such inefficiencies in transferring files over the wireless network, many cellular phones are preconfigured to limit a single video and/or audio recording to a predetermined file size. Using such cellular phones, it may not be possible to record video and/or audio with more than 2-4 minutes of content.

Therefore, there is a need to provide a cellular phone with readily accessible remote storage and the ability to silently contact authorities for help. Specifically, there is a need to provide a cellular phone with the capabilities of streaming and remotely storing photographic, video and/or audio data at a host for the purposes of personal security and surveillance. Streaming photographs, live video and/or audio to a remote host or server during an emergency situation allows the data to be instantly viewed by authorities, friends or family, such that immediate help may be dispatched accordingly. Remotely storing the data at a host or server makes it possible to retrieve and examine the data even if the phone is lost, stolen or damaged during an incident. Furthermore, as such features become common with cellular phones, they may serve not only to help resolve incidents which have already occurred, but to deter and prevent perpetrators from committing similar crimes at the outset.

### SUMMARY OF THE DISCLOSURE

In accordance with one aspect of the disclosure, a method for streaming at least one of audio, video and photographic data for personal security and surveillance is provided. The method comprises the steps of providing a cellular phone with a camera for capturing video and photographic data, a microphone for capturing audio data, a panic trigger for activating the camera and the microphone, and means for communicating with a wireless network, the wireless network communicating with at least one host with a memory; engaging the panic trigger; activating the camera; streaming at least one of the video and photographic data to the host through the wireless network; and storing at least one of the video and photographic data on the memory at the host.

In accordance with another aspect of the disclosure, a cellular phone data streaming device for personal security and surveillance is provided. The cellular phone device comprises a camera for capturing video and photographic data; a microphone for capturing audio data; a panic trigger for activating the camera; and means for communicating with a wireless network, the wireless network communicating with at least one host with a memory, the means for communicating streaming at least one of the video and photographic data to the at least one host while the panic trigger is on.

In accordance with another aspect of the disclosure, a cellular phone data streaming system for personal security and surveillance is provided. The system comprises a cellular phone, the cellular phone comprising a camera for capturing video data, a microphone for capturing audio data, a panic trigger for activating the camera and the microphone; at least one host with a memory; and a wireless network, the wireless network streaming the video and audio data to the at least one host while the panic trigger is on.

These and other aspects of this disclosure will become more readily apparent upon reading the following detailed description when taken in conjunction with the accompanying drawings.

### BRIEF DESCRIPTION OF THE DRAWINGS

FIG. 1 is a flow chart of an exemplary method for streaming photographic, video and/or audio data for personal security and surveillance constructed in accordance with the teachings of the disclosure;

FIG. 2 is a schematic diagram of an exemplary cellular phone capable of streaming photographic, video and/or audio data that may be used with the method of FIG. 1; and

FIG. 3 is a schematic diagram of an exemplary personal security and surveillance system that may be used in conjunction with the cellular phone of FIG. 2.

While the present disclosure is susceptible to various modifications and alternative constructions, certain illustrative embodiments thereof have been shown in the drawings and will be described below in detail. It should be understood, however, that there is no intention to limit the present invention to the specific forms disclosed, but on the contrary, the intention is to cover all modifications, alternative constructions, and equivalents falling with the spirit and scope of the present invention.

### DETAILED DESCRIPTION

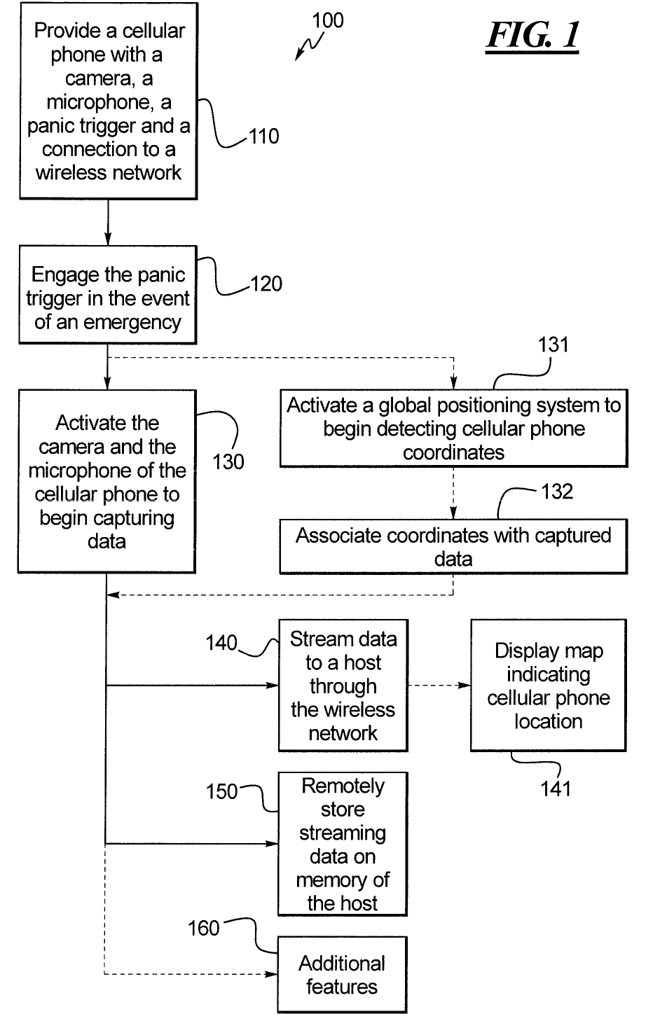

Referring to the drawings and with particular reference to FIG. 1, an exemplary method for streaming data captured at a cellular phone for personal security and surveillance is provided and referred to as reference number 100. It is understood that the teachings of the disclosure can be used to construct methods, systems and portable devices for streaming video above and beyond that specifically disclosed below. One of ordinary skill in the art will readily understand that the following are only exemplary embodiments.

The method 100 of FIG. 1 may provide streaming photographic, video and/or audio data captured at a cellular phone for the purposes of personal security and surveillance. Moreover, the method 100 may be implemented using many of the existing features of a cellular phone with a connection to a wireless network so as to provide a concealed and readily available aid to anyone with a cellular phone. The wireless network may employ one or more of any of the wireless technologies currently available, such as GSM, CDMA, WCDMA, WiMAX, WiFi, and the like. Such technologies may communicate over various frequency bands, for example, 700 MHz, 800 MHz and 1900 MHz for use in the United States, and 450 MHz, 900 MHz, 1800 MHz and 2100 MHz for us in Europe. As shown in FIG. 1, the method 100 may include an initial step 110 of providing a cellular phone with a camera, a microphone, a panic trigger and a connection to a wireless network. Upon witnessing or becoming a victim of a criminal act, or any other emergency, the cellular phone user may engage the panic trigger disposed on the cellular phone as in step 120 to begin streaming images, video and/or audio. More specifically, engaging the panic trigger may enable the camera and microphone built into the cellular phone to begin capturing images, video and/or audio data as in step 130. On supported devices, engaging the panic trigger may also activate a global positioning system (GPS) to begin detecting the location or coordinates of the cellular phone as in step 131. Alternatively, on cellular phones with GPS capability, the streaming data may be associated or tagged with the GPS coordinates in an optional step 132. As the cellular phone collects surveillance data using the camera and the microphone, the captured data may be transmitted to a host of the wireless network in the form of streaming images, video and/or audio in step 140. The host may be configured to allow anyone with access to the host to view the live data captured by the cellular phone. With respect to data captured by GPS enabled devices, the host may be configured to allow anyone with access to the host to view the location of the cellular phone. For instance, a website hosted by a wireless network or service provider may translate the GPS information into an easily readable map indicating the real-time location of the cellular phone, as in a step 141. Such information may be used by law enforcement and emergency response teams to pinpoint the location of a crime or incident and respond accordingly. Additionally, having records and access to such location information may allow authorities to verify a crime scene and to uncover valuable evidence. During the transmission of data to the host in step 140, streaming images, video and/or audio data may also be stored remotely on a database or memory at the host in an additional step 150, such that the images, video and/or audio may be examined at a later time even if the cellular phone is damaged, lost or stolen.

The method 100 for streaming data captured at a cellular phone may also accommodate additional features or steps 160 to increase personal security. For instance, in addition to the steps 140, 150 of streaming and storing data at a host, an optional step 160 of sounding a loud audible alarm from the cellular phone may serve to draw attention and to keep attackers at a distance. Alternatively, as photographic, video and/or audio data is streaming to a host, an automated alert or notification notifying authorities of a possible emergency may be transmitted as an added step 160. The alert may be transmitted to authorities or a response center in the form of a text message, email, a pre-recorded voice message, or the like, and may provide instructions for accessing the streaming data. In particular, the alert may include a link, such as a web address or uniform resource locator (URL), to the streaming or stored data captured by the cellular phone, information identifying the user of the cellular phone, and information pertaining to the geographical location of the cellular phone. Upon receiving the alert and accessing the link, authorities may examine the photographic, video and/or audio data by way of an internet connection to the host. If, after reviewing the data, there appears to be an actual emergency, authorities may respond accordingly. For instance, if information provided by the cellular phone suggests a fire, a response center may dispatch a local fire department to the location provided by the automated alert.

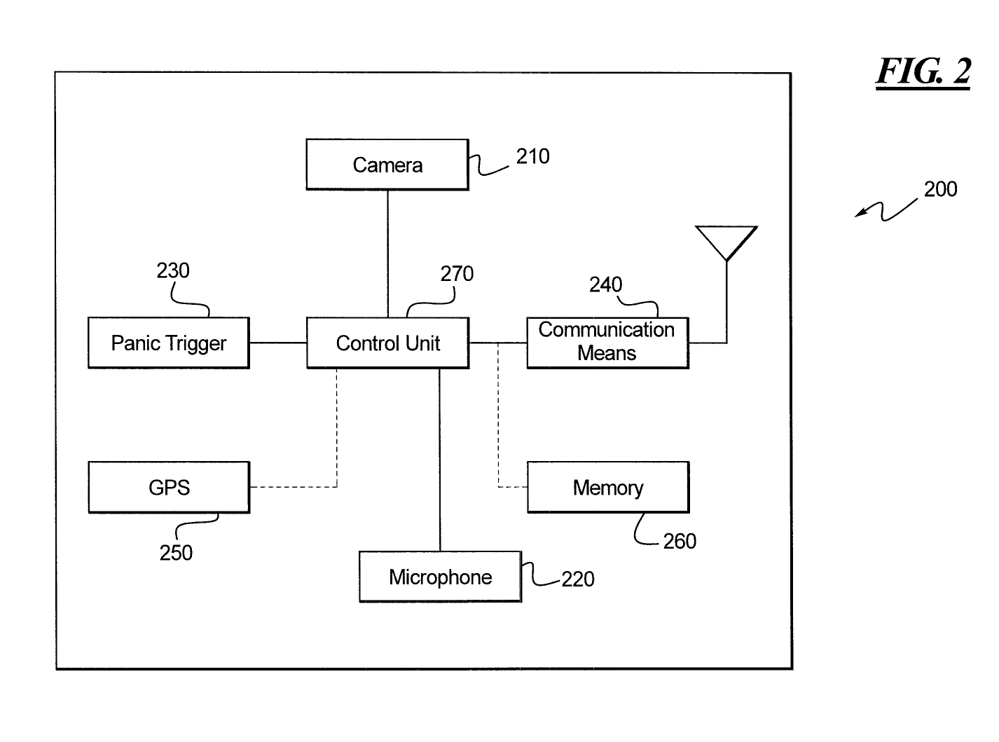

Turning now to the schematic of FIG. 2, an exemplary cellular phone 200 that may stream data for the purposes of security and surveillance is provided. Among other things, the cellular phone 200 may include a camera 210, a microphone 220 and a panic trigger 230 disposed on an exterior surface of the cellular phone 200 for easy access. Additionally, the cellular phone 200 may include communication means 240 for connecting to a wireless network or service provider, and in particular, for streaming photographic, video and/or audio data to a host of a wireless network. Communication means 240 may support wireless technologies such as GSM, CDMA, WCDMA, WiMAX, WiFi, and the like, and communicate over various frequency bands, for example, 450 MHz, 700 MHz, 800 MHz, 900 MHz, 1800 MHz, 1900 MHz, 2100 MHz, and the like. The cellular phone 200 may also incorporate a GPS 250 for determining the location of the cellular phone 200. The GPS 250 may be built-in, accessible via a cellular network, external, connected through a memory card slot or data port, or the like. Local memory 260 may also be integrated into the cellular phone 200 such that captured data may be stored locally as well as remotely at the host. Furthermore, the cellular phone 200 may employ a control unit 270 for processing information between the aforementioned components. The control unit 270 may be a microcontroller, a microprocessor, or any other programmable circuit integrated into the hardware or firmware of the cellular phone 200.

The control unit 270 may be associated with a predetermined algorithm that instructs the cellular phone 200 to capture and stream various data in the event of an emergency. Specifically, the algorithm may instruct the control unit 270 to monitor the panic trigger 230 for engagement. Once the panic trigger 230 is on, a signal or a toggle so indicating may be set at an input of the control unit 270. In response to the set input signal, the control unit 270 may begin capturing photographic, video and/or audio data using the camera 210 and the microphone 220. On supported devices, the control unit 270 may activate the GPS 250 in response to the signal set by the panic trigger 230. As sampled data from the camera 210 and the microphone 220 arrive at the control unit 270, streams of the photographic, video and/or audio data may be processed and relayed to communication means 240 for immediate transmission to a host via a wireless network. On cellular phones 200 with GPS 250, the captured data may be tagged with the coordinates of the cellular phone 200. The control unit 270 may also relay the data to local memory 260 for local storage. The algorithm may be configured to repeat such processes and stream data to a host for as long as the panic trigger 230 is on. Accordingly, while the panic trigger 230 is on, the algorithm may instruct the control unit 270 to monitor the panic trigger 230 for a reset signal. Once the panic trigger 230 is turned off, the signal or the toggle at the input of the control unit 270 may be reset, causing the control unit 270 to cease streaming of all data.

Still referring to FIG. 2, the panic trigger 230 may be implemented or incorporated into a cellular phone 200 in a number of ways. For instance, the panic trigger 230 may be a physical button, key, switch, tab, or the like, disposed on an exterior surface of the cellular phone 200. Such a physical panic trigger 230 may be positioned on an edge, corner, or any other portion of the cellular phone 200 such that the panic trigger 230 is easily distinguishable from all other buttons or keys. The panic trigger 230 may also be recessed or provided with a cover or tab to help prevent accidental engagement of the panic trigger 230. Alternatively, the panic trigger 230 may be assigned to any one of the existing keys of a cellular phone 200 according to an individual's preference. On supported cellular phones, the panic trigger 230 may also be activated using a touch-screen display or by voice command.

As previously discussed with respect to the method 100 of FIG. 1, the cellular phone 200 and the algorithm embedded therein may provide additional features to promote personal safety. For instance, while data is being streamed and stored remotely at a host, the control unit 270 may transmit an automated alert to authorities of a possible emergency. The alert may be in the form of a text message, email, pre-recorded voice message, or the like, and may contain vital information, such as information identifying the user of the cellular phone 200, the location of the cellular phone 200, and instructions for accessing the streaming images, video and/or audio. Alternatively, the captured data may be tagged with the coordinates of the cellular phone 200 and transmitted to a host. A website hosted by a wireless network or service provider may translate the GPS information into an easily readable map with a mark indicating the real-time location of the cellular phone. Using such information, authorities may be able to respond immediately and dispatch help accordingly.

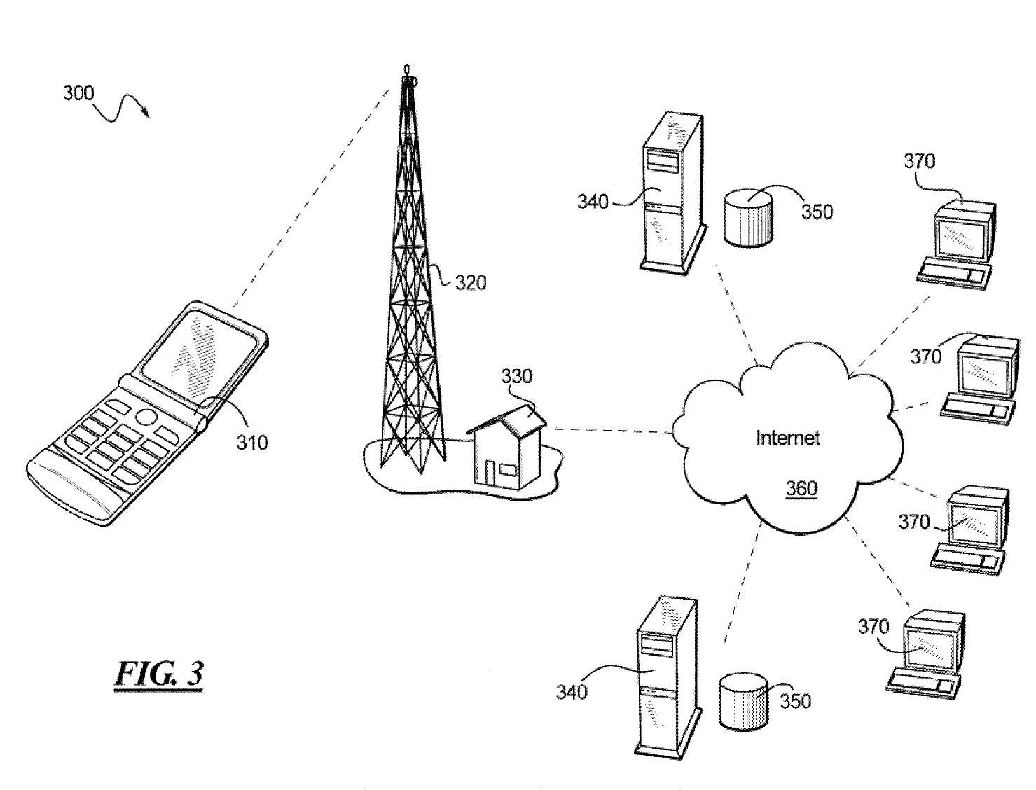

Referring now to FIG. 3, an exemplary system 300 is provided demonstrating one possible network that may support streaming and remotely storing data captured by a cellular phone 310. As previously described with reference to the cellular phone 200 of FIG. 2, the cellular phone 310 of FIG. 3 may also include a control unit, camera, microphone, panic trigger and communication means. During normal operation, the cellular phone 310 may wirelessly communicate with the nearest transmission tower 320 and data center 330 that is associated with a wireless network or service provider. The cellular phone 310 may use the same tower 320 and data center 330 for the purposes of streaming photographic, video and/or audio during an emergency. More specifically, once the panic trigger is on, streaming images, video and/or audio data may be transmitted to the nearest tower 320 and associated data center 330. From the data center 330, data may be directed to one or more hosts or servers 340 by way of the internet 360. Each server 340 may be associated with memory or a database 350 that may be local to the server 340 but remote from the cellular phone 310. In fact, each server 340 may be located anywhere in the world so long as it is accessible via the internet 360. Moreover, the servers 340 do not necessarily have to be owned by the wireless service provider of the cellular phone 310, and may be leased. As the server 340 hosts photographic, video and/or audio streams received from the data center 330 via the internet 360, the data may be simultaneously stored on the associated database 350 for future reference. Through connections with the internet 360, a server 340 and an associated database 350 may communicate with any number of devices 370 also capable of connecting to the internet 360, such as desktop computers, laptop computers, personal digital assistants (PDAs), cellular phones, and the like. Specifically, anyone connected to the internet 360 and granted access to the server 340 and database 350 may access the streaming or stored data captured by the cellular phone 310. This may include friends and family members of the cellular phone user, wireless network administrators, emergency response dispatchers, local police and fire department personnel, and the like.

Based on the foregoing, it can be seen that the present disclosure may be incorporated into cellular phones and associated wireless networks to transform modern day cellular phones into powerful security and surveillance devices. Moreover, the present disclosure provides means for automatically capturing, streaming and remotely storing data for the purposes of personal security and surveillance. The captured and streamed data may be in the form of photographic images, video data, audio data, and any combinations thereof. In the event of an emergency, images, video and/or audio may be captured covertly using existing components of a cellular phone. Simultaneously, the information may be transmitted and streamed to a host or server of the wireless network or service provider. Streaming data may also be stored at the host for future reference such that the data is available even when the cellular phone is damaged, lost or stolen. By streaming live video and/or audio captured by a witness to or victim of an incident, it may also be possible to efficiently and accurately respond to any and all types of emergencies as they occur. By automatically and remotely storing video and/or audio, it is also possible to provide valuable information or evidence about a crime or incident.

While only certain embodiments have been set forth, alternatives and modifications will be apparent from the above description to those skilled in the art. These and other alternatives are considered equivalents and within the spirit and scope of this disclosure.

What is claimed is:

1. A method for streaming at least one of audio, video and photographic data for personal security and surveillance, comprising the steps of:
providing a cellular phone with a camera for capturing video and photographic data, a microphone for capturing audio data, a panic trigger for activating the camera and the microphone, and means for communicating with a wireless network, the wireless network communicating with at least one host with a memory;
engaging the panic trigger;
activating the camera;
streaming at least one of the video and photographic data to the host through the wireless network; and
storing at least one of the video and photographic data on the memory at the host.

2. The method for streaming of claim 1, wherein the step of activating the camera also activates the microphone.

3. The method for streaming of claim 2, wherein the step of streaming at least one of the video and photographic data also streams the audio data to the host through the wireless network.

4. The method for streaming of claim 3, wherein the step of storing at least one of the video and photographic data also stores the audio data on the memory of the host.

5. The method for streaming of claim 1, further comprising the step of notifying authorities of a possible emergency.

6. The method for streaming video of claim 1, further comprising the step of activating a global positioning system to provide cellular phone location information to the host.

7. A cellular phone data streaming device for personal security and surveillance, comprising:
a camera for capturing video and photographic data;
a microphone for capturing audio data;
a panic trigger for activating the camera; and
means for communicating with a wireless network, the wireless network communicating with at least one host with a memory, the means for communicating streaming at least one of the video and photographic data to the at least one host while the panic trigger is on.

8. The cellular phone data streaming device of claim 7, wherein the panic trigger also activates the microphone.

9. The cellular phone data streaming device of claim 8, wherein the means for communicating provides streaming audio to the at least one host while the panic trigger is on.

10. The cellular phone data streaming device of claim 7, wherein the video and photographic data is stored on a memory of the cellular phone.

11. The cellular phone data streaming device of claim 7, wherein the host automatically stores the streaming video and photographic data on the memory thereof.

12. The cellular phone data streaming device of claim 7, wherein the host automatically notifies authorities of a possible emergency.

13. The cellular phone data streaming device of claim 7 further comprising a global positioning system.

14. The cellular phone data streaming device of claim 13, wherein the panic trigger activates the global positioning system providing cellular phone location information to the host.

15. The cellular phone data streaming device of claim 7, wherein the panic trigger is activated by voice command.

16. A cellular phone data streaming system for personal security and surveillance, comprising:
a cellular phone, the cellular phone comprising a camera for capturing video data, a microphone for capturing audio data, a panic trigger for activating the camera and the microphone;
at least one host with a memory; and
a wireless network, the wireless network streaming the video and audio data to the at least one host while the panic trigger is on.

17. The cellular phone data streaming system of claim 16, wherein the host automatically stores the streaming video and audio data on the memory.

18. The cellular phone data streaming device of claim 16, wherein the host automatically notifies authorities of a possible emergency.

19. The cellular phone data streaming system of claim 16, wherein the panic trigger activates a global positioning system providing cellular phone location information to the host.

20. The cellular phone data streaming system of claim 16, wherein the camera also captures photographic images.
